(19) United States
(12) Patent Application Publication
(10) Pub. No.: US 2017/0180208 A1
(43) Pub. Date: Jun. 22, 2017

(54) ORGANICALLY COMPOSABLE IOT NETWORKS

(71) Applicant: Intel Corporation, Santa Clara, CA (US)

(72) Inventors: Ned M. Smith, Beaverton, OR (US); Nathan Heldt-Sheller, Portland, OR (US)

(21) Appl. No.: 14/977,870

(22) Filed: Dec. 22, 2015

(51) Int. Cl. H04L 12/24

(52) U.S. Cl. CPC H04L 41/12; H04L 41/0813

(57) ABSTRACT

Disclosed in some examples are methods, devices, and machine readable mediums which allow for disparate IoT networks to combine forming larger networks in an organic and independent manner. Following the methods disclosed herein, the newly formed network is well formed topologically and does not require the use of gateways or other specialized devices to provide IoT realm services. Indeed, individual nodes within the network perform the key management, access management, and network operations functions that were previously performed by the gateway device.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Intel, All Rights Reserved.

### TECHNICAL FIELD

Embodiments pertain to Internet of Things (IoT) networks. Some embodiments relate to the automatic creation of IoT networks from other, disparate IoT networks.

### BACKGROUND

The IoT is a network of physical objects or “things” embedded with electronics, software, and sensors which enables these objects to collect and exchange data between themselves and between other computing devices. Example “things” include connected home appliances, sensors in automobiles, biochips, and the like. Standards groups have begun the process of formulating standards that specify procedures for device discovery, communications between devices, service discovery, security, and other procedures used in forming and maintaining IoT networks. Example groups include the Open Interconnect Consortium (OIC), Internet Protocol for Smart Objects (IPSO) Alliance, and the Industrial Internet Consortium.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a schematic of two disparate IoT realms according to some examples of the present disclosure.

FIG. 2 shows a schematic of the creation of a super-realm R3 from realm R1 and R2 according to some examples of the present disclosure.

FIG. 3 shows a schematic of a node data structure according to some examples of the present disclosure.

FIG. 4 shows a schematic of a node data structure according to some examples of the present disclosure.

FIG. 5 shows a flowchart of a method of forming a super-realm from a first and a second realm is shown according to some examples of the present disclosure.

FIG. 6 shows a schematic of an example IoT node according to some examples of the present disclosure.

FIG. 7 is a block diagram illustrating an example of a machine upon which one or more embodiments may be implemented.

### DETAILED DESCRIPTION

IoT may be described as a ‘network of networks’ where devices utilize underlying communications networks and technologies such as the Internet to communicate, but form their own logical networks of IoT devices (called nodes). These logical networks of IoT devices may be referred to as an IoT realm. In some examples, two or more disparate IoT realms may combine to form a larger realm referred to as a super-realm. The current techniques used to form these super-realms involves the use of gateways or cloud servers which take on the role of emulating, virtualizing, and representing the operation of the disparate realms outside the gateway. For example, the gateways, while serving as connectivity bridges are often tasked with the additional tasks of providing realm services that allow secure access to resources controlled by IoT nodes. These realm services include key management, access management, network operations, provisioning, node and resource discovery, and the other realm services to facilitate communication amongst the nodes of the realm. The result is that the gateway becomes a single point of failure for attack. Moreover, the use of a gateway does not scale well as the use of a gateway assumes that it will have processing and bandwidth capacity to serve networks that are expected to have 30-50 billion endpoints by the year 2020. Such growth is only achievable using cloud computing where processing moves into the cloud. However, moving IoT networks entirely into a ‘cloud’ server is not reasonable since IoT networks have a physical component that cannot move into the cloud. Organically composed IoT networks offers a solution.

Aside from scalability problems, security of the newly formed realm is also a problem. In forming these larger realms, the operational integrity of the smaller, constituent realms should be maintained. Maintaining operational integrity is important because the physical objects and sensors participating in these networks need to be protected from attack as significant real-world damage may result if attackers are able to damage these sensors. If operational integrity is not maintained when the realms form the super-realm, the larger super-realm may not enforce the same kinds of security constraints as the smaller constituent realms, opening up the devices to attack.

Disclosed in various examples are methods, devices, and machine readable mediums which allow disparate IoT realms to combine to form larger realms in an organic and independent manner. Following the mechanisms disclosed herein, the newly-formed realm is well formed topologically and does not require the use of gateways or other specialized devices to provide IoT realm services. Indeed, individual nodes within the super-realm perform the key management, access management, network operations, provisioning, node and resource discovery, and other realm services that facilitate communication amongst the nodes of the realm that were previously performed by the gateway device. This is accomplished in some examples by having a library of scripts that provide instructions to nodes on how to perform these services. The networks form using a set of rules and mechanisms that, when applied to IoT realm formation, results in a realm that may organically combine with a second, disparate, IoT realm to form a super-realm. The super-realm may then organically combine with one or more other realms to form yet another, even larger realm.

The disclosed methods, systems, and machine-readable mediums improve on the existing ad-hoc approach to linking IoT realms by defining rules for how an IoT realm topology may organically evolve such that a well-defined method exists for composing these otherwise disparate realms. This system allows disparate IoT realms to be instantiated and evolve independently indefinitely, allow IoT networks to organically merge at one or more touch points by electing a new parent node, and preserve existing operational integrity and security by cascading access and operational integrity constraints down to endpoint nodes where they may be interpreted and enforced. Script resources in a library of scripts contain access policies by specifying intended device interactions and workflows. When realms are combined, new scripts are either authored or obtained from a script library that applies a workflow interaction that may be mapped onto devices found in the disparate realms.

The IoT network building blocks comprise a set of devices (nodes) and a set of IoT realm services that are performed by the nodes. Nodes are either elected to perform one of the realm services, or assigned to perform one of the realm services. Realm services include a credentials management service, an access management service, a network operations service, a provisioning service, a node discovery service, a resource discovery service, or the like. The services may be defined by one or more scripting resources that may be obtained through a script library or are preconfigured on the nodes. A script for a service has instructions for the node on performing a given service. The script library may be accessible over a network and may be provided by a network based service.

A realm is organized into parent nodes and child nodes. The parent node is responsible for the network operations realm services (which includes parent election procedures and realm organization and management described herein) and may take responsibility for, or delegate to another node the remaining services. A realm may be formally defined as a collection of IoT nodes with a common parent node. Nodes may be both parent nodes (e.g., a parent of one realm) and child nodes (children in another realm). Thus realms may be hierarchical. Parent nodes are also responsible for ensuring that if one of the nodes in the realm that is performing one of the IoT realm services goes offline or leaves the realm, that the function is reassigned to another node. To further improve resiliency, nodes may have redundant instances of themselves. These redundant instances may be considered as a single node by the parent node.

Nodes may be categorized into three different types: top nodes, middle nodes, and endpoint nodes (T, M, E). Endpoint nodes are child nodes in a realm and have a single parent node that it looks to for provisioning of security credentials, access control policies, and cross-realm access policies. Middle nodes are nodes that are a parent in some realms, and a child in other realms. Top nodes are nodes that are only a parent node and are not a child node in any realm.

When disparate IoT realms following the disclosed procedures determine that they are to be combined, the top level parent nodes in the two networks (realms) may elect a new parent node from one or the other of the realms. The new parent creates a new realm that performs the functions of a parent node (e.g., performs or delegates the realm services that would traditionally be performed by gateways). The new realm contains the other two networks as sub-realms.

The new realm may contain realm specific operational constraints that may be enforced by the parent nodes or may be delegated to a child node for enforcement. Example constraints may include anti-virus scans of data exchanged between realms or other forms of security scanning including whitelist, blacklist, anomaly detection and privacy filtering. Other operational constraints may include information labeling (assigning a category such as HR, Engineering, Marketing; assigning a level such as Confidential, Secret, Top Secret). Operational constraints might also include scanning information of offensive words or improper disclosure of intellectual property. Delegation may be achieved by assigning realm constraints to credentials issued to realm child nodes. Since at least one of the child nodes may be a parent to a sub-realm, realm constraints at a parent realm may be cascaded down to the sub-realm through its parent. Consequently, endpoint-to-endpoint interactions may have the complete realm hierarchy represented in its credentials and access policies. These may be evaluated in such a way to prevent privilege escalations. For example, an endpoint in a first realm may have established a communication channel to an endpoint in a second realm. Information between realms may be freely exchanged except that an access policy may restrict information exchange to exclude files, records and resources not explicitly granted to the second realm (or to a specific device in the second realm). Similarly, a credential may grant a device in a second realm with privileges (such as a category or level assignment—e.g. HR-TopSecret) that a device in a first realm recognizes according to an access control list (ACL—see below) that grants access to devices bearing the privilege: HR-TopSecret (in the second realm).

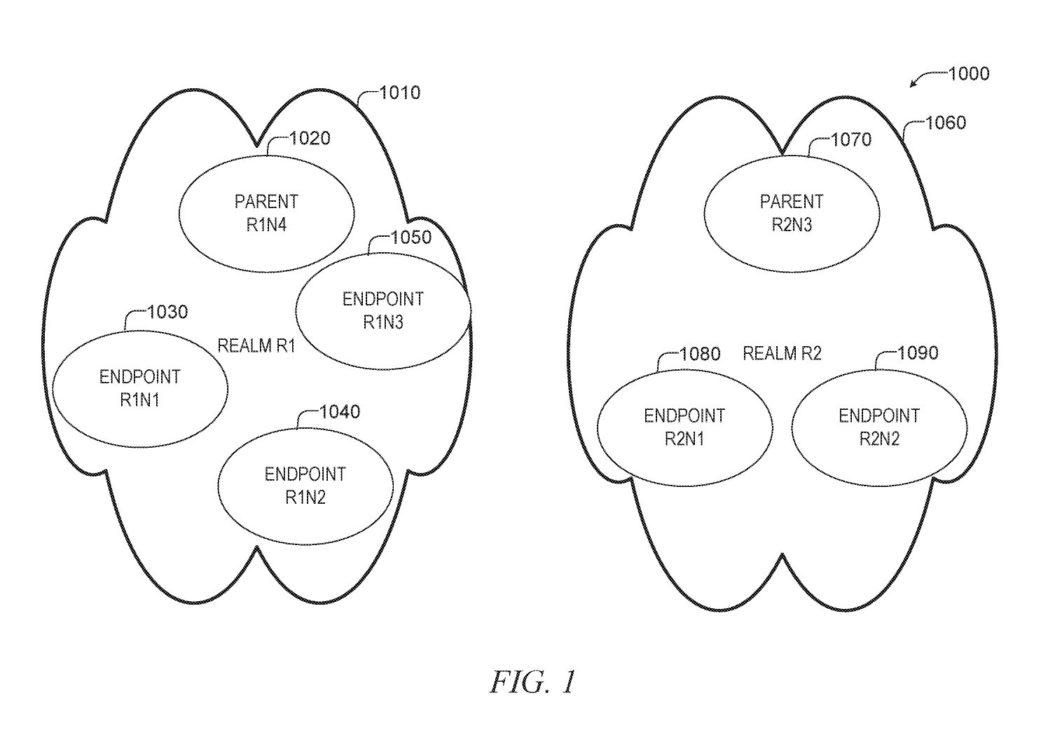

Turning now to FIG. 1, a schematic 1000 of two disparate IoT realms is shown according to some examples of the present disclosure. Realm R1 1010 includes a parent node R1N4 1020 and three endpoint nodes R1N1, R1N2, and R1N3 (1030, 1040, and 1050 respectively). Similarly, realm R2 1060 includes parent node R2N3 1070, and two endpoint nodes, R2N1 1080 and R2N2 1090.

Once realm R1 1010 and R2 1060 become communicatively reachable to one another, R1 1010 and R2 1060 may decide to form a super-realm R3 comprised of both realms R1 1010 and R2 1060. Communicatively reachable includes link, Internet, and transport layer connectivity in an Internet Engineering Task Force model for example, as well as knowledge of the existence of one another through broadcast or other discovery messages or techniques. This may be direct or may be indirect (e.g., through the third device). R1 1010 and R2 1060 may become communicatively coupled through the introduction of a device in realm R1 1010 that is communicatively coupled to R2 1060, the introduction of a device in realm R2 1060 that is communicatively coupled to R1 1010, or through the introduction of a device external to both realms R1 1010 and R2 1060 that is communicatively coupled to both R1 1010 and R2 1060.

The decision to form a super-realm may be made by agreement by parent nodes R1N4 1020 and R12N3 1070 based upon one or more policy rules from the aforementioned script resources. The policy rules may specify under what conditions a realm may join with another realm to form a new super-realm. Conditions may dictate when it is inappropriate to form a super-realm. For example, an international treaty may prohibit exchange of information (e.g., about banned technology/trade-able goods and illegal substances), where safety may be at risk, or the like. For example uranium enrichment processes should not be linked to Internet communities and social media due to the increased possibility of a hazardous materials accident. Chemical, health, environmental process automation have similar safety risk considerations that would prevent formation of super-realms under most conditions. These policy rules may be obtained from a non-volatile memory device of parent nodes 1020, 1070, or may be obtained dynamically from a script library over a network.

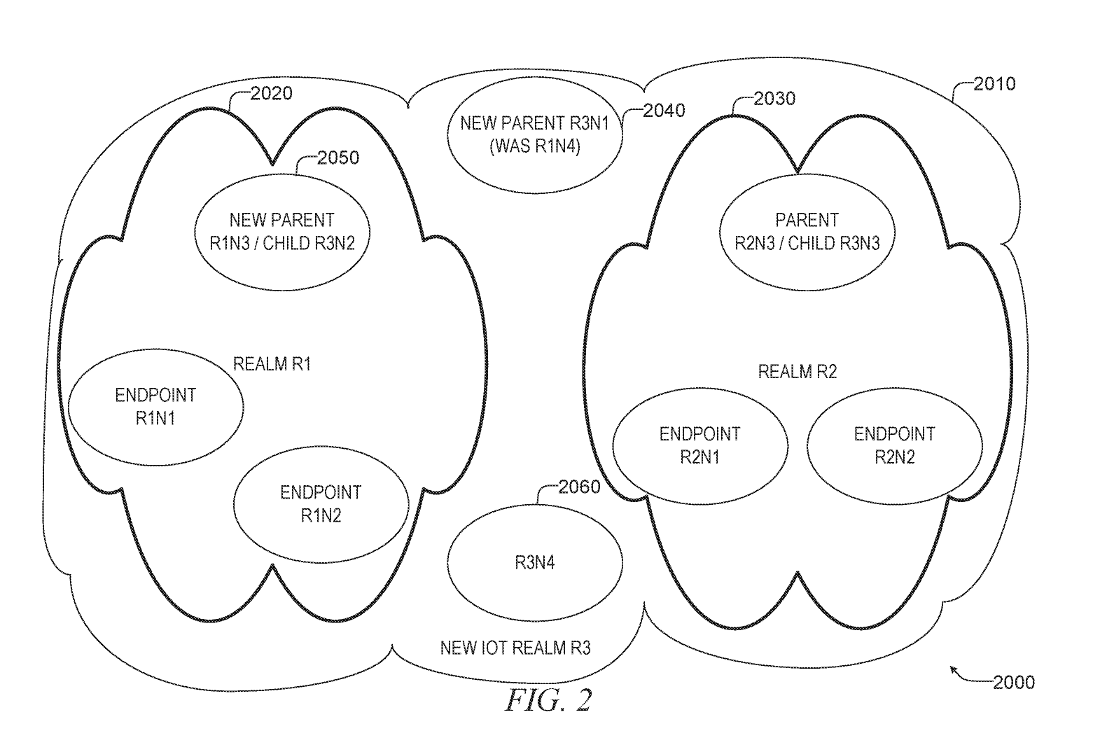

Turning now to FIG. 2 a schematic 2000 of the creation of a super-realm R3 2010 from realm R1 2020 and R2 2030 is shown according to some examples of the present disclosure. R3N4 2060 is instantiated and becomes communicatively coupled to R1 2020 and R2 2030, allowing communication between R1 2020 and R2 2030. Once the nodes are communicatively coupled, node discovery techniques in IoT implementations (e.g., through broadcasting of a node ID) allow nodes in R1 2020 and R2 2030 to become aware of each other. R1 2020 and R2 2030 decide to create the super-realm R3 2010 based upon the one or more policy rules.

Once the nodes decide to create R3 2010, an election method may be applied which may nominate an existing node in either R1 2020 or R2 2030 to serve as the parent of the new super-realm R3 2010. The procedures for electing a node may be pre-agreed upon at the time of device manufacture (and thus embedded in the code of the node), may be part of one or more scripting resources in the library of scripts (which may have been downloaded from a web service), or the like. An example election process may include electing the node with a lowest or highest identifier (e.g., a UUID, a MAC address, or the like), electing the node that is the parent of the largest constituent sub-realm, electing the node that is the parent of the smallest sub-realm, using the Mega-Merger algorithm, the Yo-Yo algorithm, or the like. In this example, R3N1 2040 (formerly R1N4) wins the election and becomes the new parent node. In some examples, a child node of realm R1 2020 is elected to take over as the new parent of R1 2020 as a result of R3N1 2040 being elected as parent of R3 2010. In the example of FIG. 2, R1N3 2050 has assumed the role of parent of R1 2020. R3 2010 is now a super-realm that orchestrates higher level control and analysis functions that previously may not have been performed by one or both of the realms R1 2020, and R2 2030. These control and analysis functions do not override any realm specific constraints (e.g., credential requirements and access control lists, and the like) on R1 2020 and R2 2030 pertaining to interactions with R3 2010.

Once the new realm R3 is created, R3N1 2040 may assign or provide one or more IoT realm services such as access management, credential management, provisioning, node discovery, resource discovery, and the like for R3 2010 to one or more nodes of realms R1 2020 and R2 2030. This assignment may be done randomly, based upon node roles assigned to the nodes through a role assignment service, processing power, or the like. In some examples, the rules for assignment of the IoT realm services may be based upon one or more scripting resources from the library of scripts. Once these tasks are assigned, the parent may broadcast these assignments to the nodes in R3 2010 (and by extension the nodes in R1 2020 and R2 2030). In other examples, the nodes assigned to these roles broadcast that they are now providing these realm services.

R3N4 2060, while only a single node, was also incorporated into R3 2010. The present disclosure contemplates the merger of one or more single nodes into one or more realms as previously described. The present disclosure also contemplates the merger of more than two disparate realms into a super-realm. For example, three, four, five or more realms may be merged to form a super-realm.

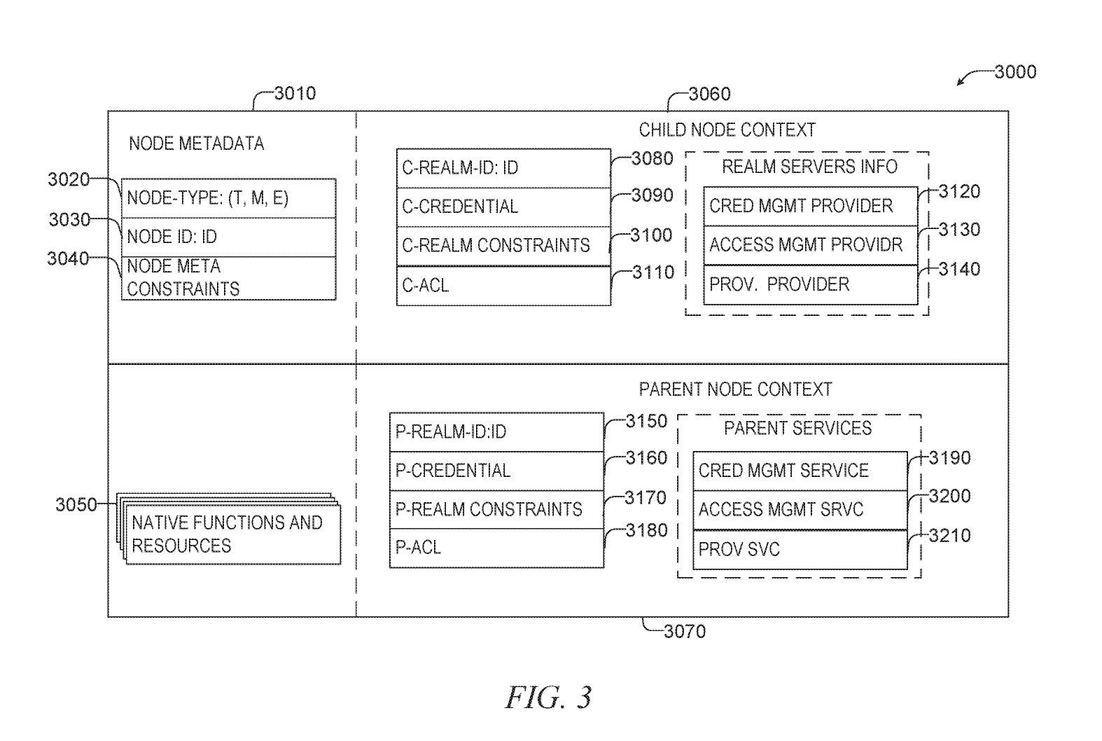

Turning now to FIG. 3, a schematic of a node data structure 3000 is shown according to some examples of the present disclosure. Node data structure 3000 may include metadata 3010. As already mentioned, nodes may be one of: top, middle, or endpoint (T, M, E). These types are stored as the node-type 3020. Nodes may be recast as part of the IoT network evolution according to one or more node meta-constraints. For example, in FIG. 2, R1N3 was recast from an endpoint node to a middle node. Node meta-constraints 3040 may specify whether a node is permitted to be recast and to what types it is permitted to be recast to. For example, a node may be constrained not to act as a parent (e.g., to only be an endpoint and not be recast as a middle or top node). These meta-constraints may be stored in the node at manufacturing time, or may be retrieved from the script library. In particular the node meta-constraints may specify constraints that check for graph circularity when making child and parent node assignments. Nodes may also have a node ID 3030 that is used to commission the node into a network. In some examples, the node ID is not used to identify the node as part of a normal operation within a defined realm. Separate IDs may be used to identify the node in realms where it is a parent and realms where it is a child. The use of multiple IDs prevents a node's activities in one realm from being tracked in another realm, increasing privacy.

Each node may also define one or more native functions and resources 3050—that is, functions associated with the actual “thing” that the device represents—for example, a smart refrigerator may have one or more functions such as temperature, status, and the like. These native functions may include one or more resources (e.g., properties) that are visible to other nodes in the child and parent realms, depending on the access constraints and credentials.

Within the context of IoT network construction, there are two additional contexts, one defining the node behavior when acting as a child 3060, and another context that is valid when a node is a parent that defines the node behavior when acting as a parent 3070. A child node context 3060 includes a child realm ID 3080 assignment (the first realm in which the node is a child.) Child realm ID 3080 is an ID used by the child within the realm in which this node is a child. This realm ID may be different than the realm ID utilized for the realm in which the node is a parent. This is to prevent the node from being tracked. Child node context 3060 also includes child realm credentials 3090, which may be one or more credentials used when functioning as a child node that were issued by the credential services for the realm in which this node is a child. Child node context 3060 also includes child realm constraints 3100. Constraints may include for example, a requirement to sanitize resource data to ensure it meets the quality, integrity, and privacy requirements. Child node context 3060 also includes access control lists (ACLs) that may be applied when another node who is a member of the same realm or other realms to which this node is a child seeks access to native functions and resources 3050. The child node may require realm specific services such as key management, access management, network operations, provisioning, node and resource discovery, and the other realm services. Child node context 3060 includes identifiers for providers of those realm services, such as credential management provider 3120, access management provider 3130 and provisioning provider 3140. Other identifiers of other realm services may be stored as needed. Identifiers may include the node identifiers of the nodes providing these realm services, contact information (such as IP address) or the like.

If the node is of type T or M, parent node context 3070 is used. Parent node context 3070 mirrors the structure of child node context 3060 allowing the parent to simultaneously exist in a second realm. Parent node context 3070 includes parent realm ID 3150 which uniquely identifies the node in the parent realm. This ID may be different than child realm ID 3080 or node ID 3030 to prevent tracking this node in multiple realms. Parent credentials 3160 may be one or more credentials used when functioning as a parent node that were issued by the credential services for the realm in which the node is a parent. Parent node context 3070 also includes parent-realm constraints 3170. For example, a parent may assert that all data produced by IoT devices within its realm is labeled as Top Secret. The parent realm constraint may cause the child to include a metadata tag on data the child device produces detailing its security classification. Parent node context 3070 also includes access control lists (ACLs) that may be applied when a device in the realm to which this node is a parent seeks access to resources 3180, or resources of another node when the parent serves as an ACL provisioning service. The use of separate ACL contexts enable child nodes in the sub-realm (the realm to which this node is a parent) to access native functions and resources without requiting exposure to the super-realm (the realm in which this node is a child). This isolation ensures autonomous network operations while allowing the “M” node type to host native functions and resources that are visible to both of its realms. In some examples, safety and security considerations may prevent exposure of native functions and resources in two realms simultaneously. Advanced node architectures may address this by creating virtualized or containerized native functions. In other examples, an implementation may have an ACL that denies access to some of the resources to one of the realms.

The parent node may assign or provide realm specific services for child nodes in the sub-realm, such as key management, access management, provisioning services, node discovery and resource discovery functions, or the like. The nodes providing these realm services may be advertised to other nodes in the realm as part of parent node operations. Parent node context 3070 includes the node identifiers for these realm services, such as credential management provider 3190, access management provider 3200 and provisioning service provider 3210 and the like. Identifiers may include the node identifiers of the nodes providing these realm services, contact information (such as IP address) or the like. In some examples the node may provide these realm services in the realm in which it is a parent.

In some examples, under certain circumstances, it may be appropriate for the parent node to forward realm service requests that cannot be satisfied immediately by it by soliciting help from the child node realm servers. This may occur when a child node of a sub realm seeks credentials to interact with a peer realm that is reachable through realm services contained in the super-realm. Hence, the desired behavior is that of a hierarchical network topology.

In some examples, a node may be a “T” level node that supplies or manages top level parent node realm services and native functions. There may be use cases where peer top level nodes do not desire formation of a new super-realm, yet desire shared access between peer top level nodes. This shared access may be facilitated by an Internet DNS Named Entities (DANE) RFC6698 service that populates some of the child node parameters without causing the node type to change to “M.” In these examples, the realm servers for credential management provider and provisioning provider forward requests to ta DANE server to obtain verification credentials applied to the respective peer node. DANE may additionally provide data that specifies a whitelist or blacklist of peers that has been determined are appropriate for the requesting node to apply when seeking to establish a connection to a peer top level node.

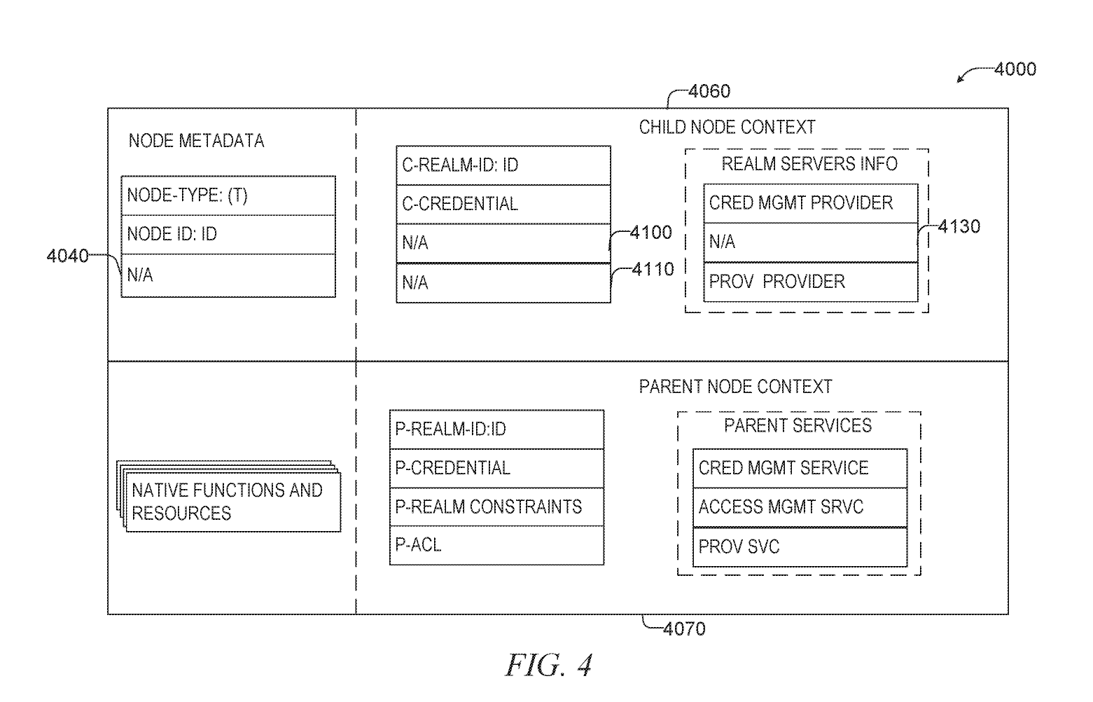

Turning now to FIG. 4, a schematic of a node data structure 4000 is shown according to some examples of the present disclosure. This structure contains a child node context 4060 and a parent node context 4070. In this data structure, the node is a T type node according to some examples of the present disclosure and it has established a peer relationship with another node in another realm through a DANE server. In this example, the fields of the meta data structure are the same as that of FIG. 3 except that meta constraints 4040, child realm constraints 4100, child realm ACL 4110 and access management provider 4130 are not applicable in this case. The access management provider 4130 is provided by the DANE Server.

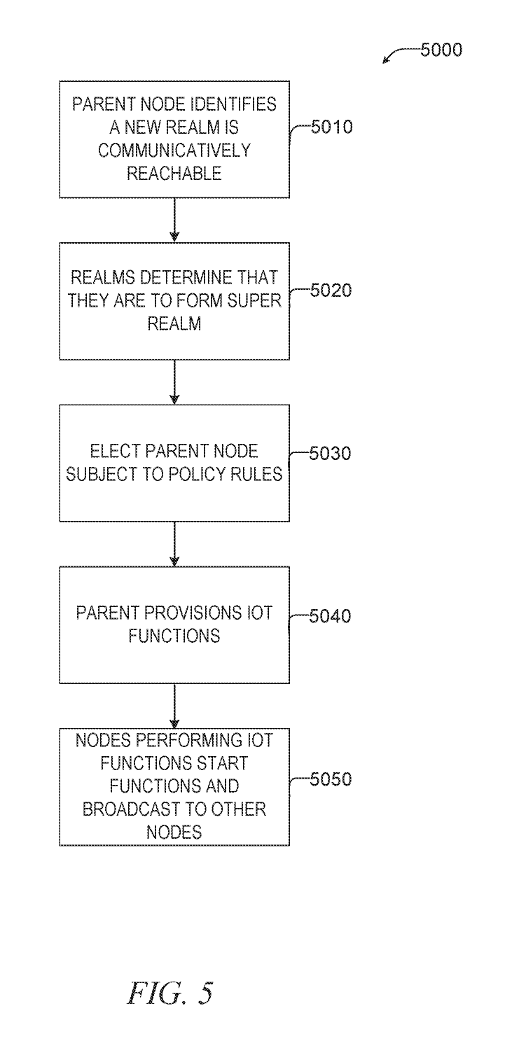

Turning now to FIG. 5, a flowchart of a method 5000 of forming a super-realm from a first and a second realm is shown according to some examples of the present disclosure. At operation 5010 the parent nodes of the first and second realms discover that the other realm is communicatively reachable. This may be the result of a new device being added to one of the realms or a third device that is reachable by the first and second realms. An example device may include a gateway.

At operation 5020 the realms agree to form a super-realm. In some examples, the parent nodes of each realm may evaluate one or more policy rules for the network. Example policy rules may include a white list of devices or realms that are safe to create a super-realm with, a black list that indicates devices or realms to which the realm should not create a super-realm with and the like. In other examples, the policy may contain rules of how many super-realms to create. For example, at a certain size, the nodes may not wish to add additional layers. In still other examples, the policy may specify that the realm is not to create a super-realm (e.g., the realm is very security sensitive). Policy rules may be stored in the library of scripts and may be obtained from a network server. In evaluating the policy, the parent nodes may evaluate the policy rules individually and then if creating the super-realm satisfies each individual policy the parent node indicates to the other parent node that it agrees to create the super-realm. If both parent nodes agree, the realms have agreed to form the super-realm.

At operation 5030 the parent nodes of each constituent realm elect a new parent node for the new super-realm. The procedures for electing a node may be pre-agreed upon at the time of device manufacture (and thus embedded in the code of the node), may be part of one or more scripting resources downloaded from a web service, or the like. An example election process may include electing the node with a lowest or highest identifier (e.g., a UUID, a MAC address, or the like), electing the node that is the parent of the largest sub-realm, electing the node that is the parent of the smallest sub-realm, using the Mega-Merger algorithm, the Yo-Yo algorithm, or the like. In some examples, the constituent realm for which the parent node was elected the parent node of the super-realm may elect a new parent for the constituent realm. Elections may proceed as described for electing the super-realm. In some examples, node meta-constraints may determine that one or more of the nodes of the realm may not be the parent of the new super-realm, or a parent of one of the constituent realms. In these examples, the node that is disqualified is removed from the election process. If only one node remains in the election process, the other node is elected by default.

At operation 5040 the parent of the super-realm provisions IoT realm services, such as key management, access management, network operations, provisioning, node and resource discovery, and the other realm services to facilitate communication amongst the nodes of the realm. The parent may provision one or more of these realm services to itself, or to parent nodes of the constituent realms, or to child nodes of the constituent realms of the super-realm. This assignment may be random (e.g., a random node in the super-realm is selected), may be assigned based upon role (e.g., some nodes are of a certain capability to perform these realm services), or the like.

At operation 5050, the nodes that were assigned their IoT realm services start performing these functions. The identities and contact information for these nodes are broadcast to other nodes so those nodes may utilize the services provided.

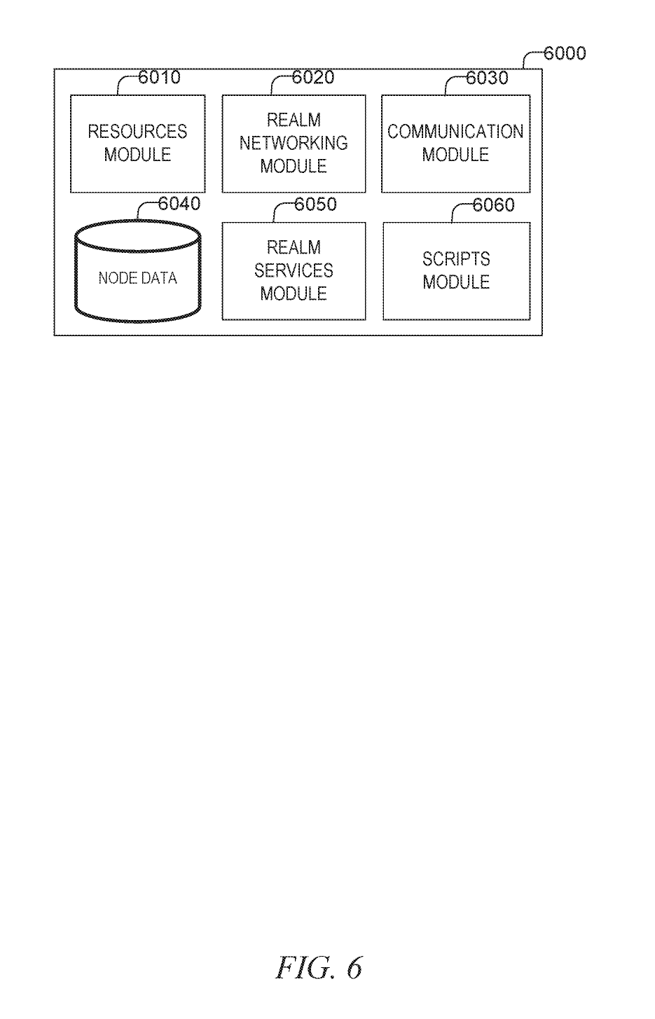

Turning now to FIG. 6, a schematic of an example IoT node 6000 according to some examples of the present disclosure. IoT node 6000 is a computing device. Example computing devices include smart meters, smart sensors, connected thermostats, connected smoke alarms, security systems, smart phones, laptops, desktop computers, tablet computers, servers, and the like. IoT node 6000 includes one or more resources modules 6010 which execute operations on the computing device for implementing the functions of the IoT device. Resources modules 6010 may provide and manage IoT resources and functions. IoT resources are specific to the type of IoT node 6000 and implement the functions of the device. For example, for a connected thermostat, resources may include an ability to set or change a heating or cooling set point, turning the system on or off, and changing one or more settings of the system.

IoT node 6000 includes a realm networking module 6020 which implements the node's participation in an IoT realm. Realm networking module 6020 implements the creation and management of IoT realms. Realm networking module 6020 determines the role of this node based upon node meta-constraints (which may be stored in node data 6040). Roles include parent or child and Top, Middle, and Endpoint. Realm networking module 6020 may implement the method of FIG. 5 to detect another realm, determine that a realm to which this node is a parent is to merge with another realm to form a super-realm, elect a new parent of the super-realm, and assign nodes to perform IoT realm services for the new super-realm.

Realm networking module 6020 determines based upon one or more access control lists (ACLs) whether a request from another IoT device for IoT resources and functions is allowed or denied. Realm networking module 6020 obtains credentials for the device from one or more credentialing services advertised to the IoT node 6000. Credentials may be stored in node data 6040 and may be used to authenticate the IoT node 6000 to other nodes and to communicate securely with other IoT nodes.

Communication module 6030 implements layers of a networking protocol stack necessary to enable node-to-node communications. These layers may include physical layers, link layers, internet layers, transport layers, and in some cases certain application layer protocols (e.g., HyperText Transfer Protocol (HTTP)). In some examples, nodes may communicate with each other using HTTP. In some examples, nodes utilize a representational state transfer (REST) protocol.

Node data 6040 includes node data and contexts as shown in FIGS. 3 and 4. Node data 6040 may include access control lists (ACLs), meta-constraints for this node, policies on realm formation, other policies and the like. The data in node data 6040 may be preloaded by the device manufacturer, or may be provided by one or more remote data sources. In some examples, ACLs, policies, and the like may be updated by one or more other IoT nodes that are authorized to update this data.

Realm services module 6050 may provide one or more IoT realm services such as key management, access management, network operations, provisioning, node and resource discovery, and the other realm services to facilitate communication amongst the nodes of the realm. In some examples, the realm services are provided by executing one or more scripts from scripts module 6060. Scripts module 6060 may store, manage, create, and or retrieve one or more scripts. A further description of these realm services is provided in the text that follows.

### Access Management Realm Services

Access Control Lists (ACLs) are predefined set of access policies and rules for accessing resources and functions of a node. Each node that has a resource that may be accessed by another node has an associated ACL. ACLs contain one or more Access Control Entries (ACE). Each ACE is either a subject-based access control (SBAC) entry or Role-based Access control (RBAC) entry. SBAC entries contain an identity of another node, a resource, and a set of permissions for access by that entity to the resource. RBAC entries contain a role of another node, a resource, and a set of permissions for access by that role to the resource. Permissions are defined by whether or not the entity described in the ACE has Create, Read, Update, Delete, and Notify (CRUDN) permissions. When a requesting node is requesting access to a resource from a server node the requesting node presents its credentials to the server node. The server node validates the credentials (to validate the identity of the requester) and then examines its ACL to determine if the requesting node has permission to access the resource. If the ACL determines that the requesting node does not have permission, the request will be denied. An ACL may be pre-programmed into the node, or may be obtained from an Access Management Service (AMS).

While nodes may host ACLs locally, an AMS may centralize access control decisions. As noted above, the AMS may be implemented by one or more of the nodes of a realm. Server nodes still retain enforcement duties. When a node requests a function or resource, it contacts the server node. The server node may consult its local ACL, which redirects the request to the AMS. The server node then contacts the AMS, who either accepts or rejects the access based upon its centralized ACL. This response is then forwarded to the requester node. In other examples, the server node redirects the client to the AMS. If the AMS grants permission it grants a signed ACL (SACL) resource to the requestor node. The requestor node then re-requests access to the function or resource and includes the SACL. The SACL is then validated by the server node and if it validates, then access is granted.

Both ACL provisioning realm services and Access Manager realm services may be services provisioned by a parent node for a realm. These services may be performed by the parent node or by one or more child nodes.

### Key Management Realm Services

Key management functions include provisioning and managing credentials. Credential provisioning services provision many different types of credentials to nodes. These include pairwise symmetric keys, group symmetric keys, asymmetric keys, and signed asymmetric keys. These keys are used to securely communicate with other nodes on the network and are created through communications with the credential provisioning realm services. Keys are used by nodes to authenticate each other when access to a resource on one of the nodes is requested. Key management functions also include revoking issued credentials if needed. This is through the maintenance of a list of revoked credentials and their corresponding devices.

### Provisioning Realm Services

Provisioning includes providing the new IoT node information necessary to join the realm and to access IoT realm services. Example information includes node discovery, geographical location, time zone, security requirements, and the like. This information may be preloaded on an IoT node or may be acquired from the provisioning service.

### Node Discovery and Resource Discovery Realm Services

Node discovery is the process by which nodes discover each other. This may be done by sending a discovery request to a multi-cast address. Nodes that are subscribed to this address send replies to the requester node. Resource discovery is the process by which nodes discover resources of other nodes. This discovery process may be direct, indirect, or the like. Direct discovery is where resources are published locally at the node hosting the devices and are discovered through peer inquiry. Indirect discovery is where resources are published to a third party resource discovery service and nodes publish and perform discovery against this service. Node discovery and resource discovery realm services may assist the process of node and resource discovery by maintaining a list of nodes, functions, and resources available within the realm. Nodes publish their presence and their resources and functions to the service and are also able to discover other nodes and their resources and functions through the service.

While the above realm services have been described separately, one of ordinary skill in the art with the benefit of Applicant's disclosure will appreciate that the services may be combined or services listed may be divided into sub-services. In yet other examples, other services, may be provided by the parent node in a realm or delegated to a child node.

### Machine Hardware Description

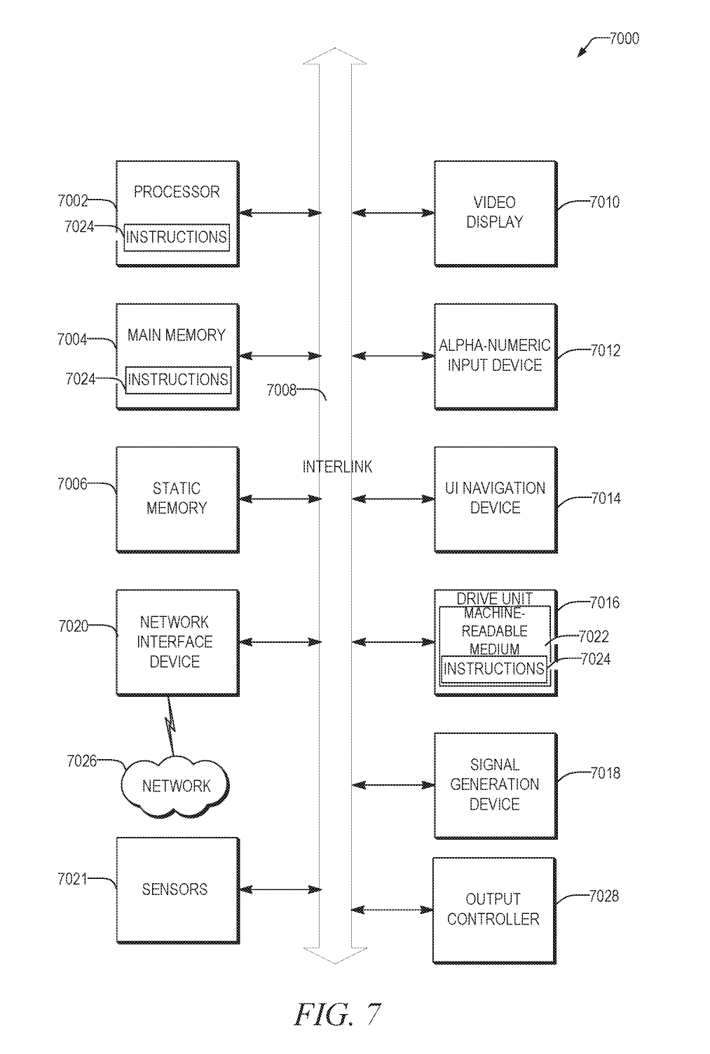

FIG. 7 illustrates a block diagram of an example machine 7000 upon which any one or more of the techniques (e.g., methodologies) discussed herein may perform. In alternative embodiments, the machine 7000 may operate as a standalone device or may be connected (e.g., networked) to other machines. In a networked deployment, the machine 7000 may operate in the capacity of a server machine, a client machine, or both in server-client network environments. In an example, the machine 7000 may act as a peer machine in peer-to-peer (P2P) (or other distributed) network environment. The machine 7000 may be an IoT node (e.g., a computing device), personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 7000 may include a hardware processor 7002 (e.g., a central processing unit (CPU), a graphics processing unit (GPU), a hardware processor core, or any combination thereof), a main memory 7004 and a static memory 7006, some or all of which may communicate with each other via an interlink (e.g., bus) 7008. The machine 7000 may further include a display unit 7010, an alphanumeric input device 7012 (e.g., a keyboard), and a user interface (UI) navigation device 7014 (e.g., a mouse). In an example, the display unit 7010, input device 7012 and UI navigation device 7014 may be a touch screen display. The machine 7000 may additionally include a storage device (e.g., drive unit) 7016, a signal generation device 7018 (e.g., a speaker), a network interface device 7020, and one or more sensors 7021, such as a global positioning system (GPS) sensor, compass, accelerometer, or other sensor. The machine 7000 may include an output controller 7028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 7016 may include a machine readable medium 7022 on which is stored one or more sets of data structures or instructions 7024 (e.g., software) embodying or utilized by any one or more of the techniques or functions described herein. The instructions 7024 may also reside, completely or at least partially, within the main memory 7004, within static memory 7006, or within the hardware processor 7002 during execution thereof by the machine 7000. In an example, one or any combination of the hardware processor 7002, the main memory 7004, the static memory 7006, or the storage device 7016 may constitute machine readable media.

While the machine readable medium 7022 is illustrated as a single medium, the term “machine readable medium” may include a single medium or multiple media (e.g., a centralized or distributed database, and/or associated caches and servers) configured to store the one or more instructions 7024.

The term “machine readable medium” may include any medium that is capable of storing, encoding, or carrying instructions for execution by the machine 7000 and that cause the machine 7000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 7024 may further be transmitted or received over a communications network 7026 using a transmission medium via the network interface device 7020. The machine 7000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 7020 may include one or more physical jacks (e.g., Ethernet, coaxial, or phone jacks) or one or more antennas to connect to the communications network 7026. In an example, the network interface device 7020 may include a plurality of antennas to wirelessly communicate using at least one of single-input multiple-output (SIMO), multiple-input multiple-output (MIMO), or multiple-input single-output (MISC) techniques. In some examples, the network interface device 7020 may wirelessly communicate using Multiple User MIMO techniques.

### Other Notes and Examples

Example 1 is a non-transitory machine readable medium, including instructions, which when performed by the machine, cause the machine to perform operations comprising: at a parent node in a first realm comprising at least one child node: determining that a second realm comprising at least one parent node is communicatively reachable to the first realm; determining to form a third realm comprising the first and second realms as sub-realms through agreement with the parent node of the second realm; electing, through an election process, the parent node of the first realm as a parent node of the third realm; provisioning at least one realm service to service at least one request of a child node of the third realm; and broadcasting the at least one realm service to child nodes of the third realm

In Example 2, the subject matter of Example 1 optionally includes, wherein the at least one realm service comprises one of: a credentials management service, an access management service, a provisioning service, a node discovery service, or a resource discovery service.

In Example 3, the subject matter of any one or more of Examples 1-2 optionally include, wherein the operations for determining to form a third realm comprising the first and second realms comprises the operations of determining that a policy rule obtained from a server indicates that the first and second realms should form a third realm.

In Example 4, the subject matter of any one or more of Examples 1-3 optionally include; wherein the operations for provisioning the at least one realm service to service at least one request of the child node of the third realm comprises the operations of providing the at least one realm service at the parent node.

In Example 5, the subject matter of Example 4 optionally includes, wherein providing the at least one realm service at the parent node comprises executing instructions from a script obtained over a network from a library of scripts.

In Example 6, the subject matter of any one or more of Examples 1-5 optionally include, wherein the operations for provisioning the at least one realm service to service at least one request of the child node of the third realm comprises the operations of assigning a child node of the first realm to provide the at least one realm service.

In Example 7, the subject matter of any one or more of Examples 1-6 optionally include, wherein the operations comprise: determining that a fourth realm comprising at least one parent node is communicatively reachable to the third realm; determining, through communication with the parent node of the fourth realm to form a fifth realm comprising the third realm and fourth realm as sub-realms; and electing, through an election process, the parent node of the fourth realm as a parent node of the fifth realm.

In Example 8, the subject matter of Example 7 optionally includes, wherein the operations comprise: providing a first access control list for the third realm and a second access control list for the fifth realm, the first access control list specifying access controls for at least one resource of the parent node for other nodes in the third realm, the second access control list specifying access controls for the at least one resource for other nodes in the fifth realm.

In Example 9, the subject matter of Example 8 optionally includes, wherein the access control list includes an identifier of the at least one resource, an identifier of a node, and an identifier of a type of access allowed for the node.

In Example 10, the subject matter of any one or more of Examples 8-9 optionally include, wherein the access control list includes an identifier of the at least one resource, an identifier of a role, and an identifier of a type of access allowed for the role.

Example 11 is a device comprising: a computer processor; a non-transitory memory, that stores instructions, which when performed by the computer processor, cause the device to perform operations comprising: at a parent node in a first realm comprising at least one child node: determining that a second realm comprising at least one parent node is communicatively reachable to the first realm; determining to form a third realm comprising the first and second realms as sub-realms through agreement with the parent node of the second realm; electing, through an election process, the parent node of the first realm as a parent node of the third realm; provisioning at least one realm service to service at least one request of a child node of the third realm; and broadcasting the at least one realm service to child nodes of the third realm

In Example 12, the subject matter of Example 11 optionally includes, wherein the at least one realm service comprises one of: a credentials management service, an access management service, a provisioning service, a node discovery service, or a resource discovery service.

In Example 13, the subject matter of any one or more of Examples 11-12 optionally include, wherein the operations for determining to form a third realm comprising the first and second realms comprises the operations of determining that a policy rule obtained from a server indicates that the first and second realms should form a third realm.

In Example 14, the subject matter of any one or more of Examples 11-13 optionally include, wherein the operations for provisioning the at least one realm service to service at least one request of the child node of the third realm comprises the operations of providing the at least one realm service at the parent node.

In Example 15, the subject matter of Example 14 optionally includes, wherein providing the at least one realm service at the parent node comprises executing instructions from a script obtained over a network from a library of scripts.

In Example 16, the subject matter of any one or more of Examples 11-15 optionally include, wherein the operations for provisioning the at least one realm service to service at least one request of the child node of the third realm comprises the operations of assigning a child node of the first realm to provide the at least one realm service.

In Example 17, the subject matter of any one or more of Examples 11-16 optionally include, wherein the operations comprise: determining that a fourth realm comprising at least one parent node is communicatively reachable to the third realm; determining, through communication with the parent node of the fourth realm to form a fifth realm comprising the third realm and fourth realm as sub-realms; and electing, through an election process, the parent node of the fourth realm as a parent node of the fifth realm.

In Example 18, the subject matter of Example 17 optionally includes, wherein the operations comprise: providing a first access control list for the third realm and a second access control list for the fifth realm, the first access control list specifying access controls for at least one resource of the parent node for other nodes in the third realm, the second access control list specifying access controls for the at least one resource for other nodes in the fifth realm.

In Example 19, the subject matter of Example 18 optionally includes, wherein the access control list includes an identifier of the at least one resource, an identifier of a node, and an identifier of a type of access allowed for the node.

In Example 20, the subject matter of any one or more of Examples 18-19 optionally include, wherein the access control list includes an identifier of the at least one resource, an identifier of a role, and an identifier of a type of access allowed for the role.

Example 21 is a method comprising: at a parent node in a first realm comprising at least one child node, using a computer processor: determining that a second realm comprising at least one parent node is communicatively reachable to the first realm; determining to form a third realm comprising the first and second realms as sub-realms through agreement with the parent node of the second realm; electing, through an election process, the parent node of the first realm as a parent node of the third realm; provisioning at least one realm service to service at least one request of a child node of the third realm; and broadcasting the at least one realm service to child nodes of the third realm

In Example 22, the subject matter of Example 21 optionally includes, wherein the at least one realm service comprises one of: a credentials management service, an access management service, a provisioning service, a node discovery service, or a resource discovery service.

In Example 23, the subject matter of any one or more of Examples 21-22 optionally include, wherein determining to form a third realm comprising the first and second realms comprises determining that a policy rule obtained from a server indicates that the first and second realms should form a third realm.

In Example 24, the subject matter of any one or more of Examples 21-23 optionally include, wherein provisioning the at least one realm service to service at least one request of the child node of the third realm comprises providing the at least one realm service at the parent node.

In Example 25, the subject matter of Example 24 optionally includes, wherein providing the at least one realm service at the parent node comprises executing instructions from a script obtained over a network from a library of scripts.

In Example 26, the subject matter of any one or more of Examples 21-25 optionally include, wherein provisioning the at least one realm service to service at least one request of the child node of the third realm comprises assigning a child node of the first realm to provide the at least one realm service.

In Example 27, the subject matter of any one or more of Examples 21-26 optionally include: determining that a fourth realm comprising at least one parent node is communicatively reachable to the third realm; determining, through communication with the parent node of the fourth realm to form a fifth realm comprising the third realm and fourth realm as sub-realms; and electing, through an election process, the parent node of the fourth realm as a parent node of the fifth realm.

In Example 28, the subject matter of Example 27 optionally includes: providing a first access control list for the third realm and a second access control list for the fifth realm, the first access control list specifying access controls for at least one resource of the parent node for other nodes in the third realm, the second access control list specifying access controls for the at least one resource for other nodes in the fifth realm.

In Example 29; the subject matter of Example 28 optionally includes, wherein the access control list includes an identifier of the at least one resource, an identifier of a node, and an identifier of a type of access allowed for the node.

In Example 30, the subject matter of any one or more of Examples 28-29 optionally include, wherein the access control list includes an identifier of the at least one resource; an identifier of a role, and an identifier of a type of access allowed for the role.

Example 31 is a device comprising: at a parent node in a first realm comprising at least one child node, using a computer processor: means for determining that a second realm comprising at least one parent node is communicatively reachable to the first realm; means for determining to form a third realm comprising the first and second realms as sub-realms through agreement with the parent node of the second realm; means for electing, through an election process, the parent node of the first realm as a parent node of the third realm; means for provisioning at least one realm service to service at least one request of a child node of the third realm; and means for broadcasting the at least one realm service to child nodes of the third realm

In Example 32, the subject matter of Example 31 optionally includes, wherein the at least one realm service comprises one of: a credentials management service, an access management service, a provisioning service, a node discovery service, or a resource discovery service.

In Example 33, the subject matter of any one or more of Examples 31-32 optionally include, wherein means for determining to form a third realm comprising the first and second realms comprises means for determining that a policy rule obtained from a server indicates that the first and second realms should form a third realm.

In Example 34, the subject matter of any one or more of Examples 31-33 optionally include, wherein means for provisioning the at least one realm service to service at least one request of the child node of the third realm comprises means for providing the at least one realm service at the parent node.

In Example 35, the subject matter of Example 34 optionally includes, wherein means for providing the at least one realm service at the parent node comprises means for executing instructions from a script obtained over a network from a library of scripts.

In Example 36, the subject matter of any one or more of Examples 31-35 optionally include, wherein means for provisioning the at least one realm service to service at least one request of the child node of the third realm comprises means for assigning a child node of the first realm to provide the at least one realm service.

In Example 37, the subject matter of any one or more of Examples 31-36 optionally include: means for determining that a fourth realm comprising at least one parent node is communicatively reachable to the third realm; means for determining, through communication with the parent node of the fourth realm to form a fifth realm comprising the third realm and fourth realm as sub-realms; and means for electing, through an election process, the parent node of the fourth realm as a parent node of the fifth realm.

In Example 38, the subject matter of Example 37 optionally includes: means for providing a first access control list for the third realm and a second access control list for the fifth realm, the first access control list specifying access controls for at least one resource of the parent node for other nodes in the third realm, the second access control list specifying access controls for the at least one resource for other nodes in the fifth realm.

In Example 39, the subject matter of Example 38 optionally includes, wherein the access control list includes an identifier of the at least one resource, an identifier of a node, and an identifier of a type of access allowed for the node.

In Example 40, the subject matter of any one or more of Examples 38-39 optionally include, wherein the access control list includes an identifier of the at least one resource, an identifier of a role, and an identifier of a type of access allowed for the role.

What is claimed is:

1. A non-transitory machine readable medium, including instructions, which when performed by the machine; cause the machine to perform operations comprising
at a parent node in a first realm comprising at least one child node:
determining that a second realm comprising at least one parent node is communicatively reachable to the first realm;
determining to form a third realm comprising the first and second realms as sub-realms through agreement with the parent node of the second realm;
electing, through an election process, the parent node of the first realm as a parent node of the third realm;
provisioning at least one realm service to service at least one request of a child node of the third realm; and
broadcasting the at least one realm service to child nodes of the third realm.

2. The machine-readable medium of claim 1, wherein the at least one realm service comprises one of: a credentials management service, an access management service, a provisioning service, a node discovery service, or a resource discovery service.

3. The machine-readable medium of claim 1, wherein the operations for determining to form a third realm comprising the first and second realms comprises the operations of determining that a policy rule obtained from a server indicates that the first and second realms should form a third realm.

4. The machine-readable medium of claim 1, wherein the operations for provisioning the at least one realm service to service at least one request of the child node of the third realm comprises the operations of providing the at least one realm service at the parent node.

5. The machine-readable medium of claim 4, wherein providing the at least one realm service at the parent node comprises executing instructions from a script obtained over a network from a library of scripts.

6. The machine-readable medium of claim 1, wherein the operations for provisioning the at least one realm service to service at least one request of the child node of the third realm comprises the operations of assigning a child node of the first realm to provide the at least one realm service.

7. The machine-readable medium of claim 1, wherein the operations comprise:
determining that a fourth realm comprising at least one parent node is communicatively reachable to the third realm;
determining, through communication with the parent node of the fourth realm to form a fifth realm comprising the third realm and fourth realm as sub-realms; and
electing, through an election process, the parent node of the fourth realm as a parent node of the fifth realm.

8. The machine-readable medium of claim 7, wherein the operations comprise: providing a first access control list for the third realm and a second access control list for the fifth realm, the first access control list specifying access controls for at least one resource of the parent node for other nodes in the third realm, the second access control list specifying access controls for the at least one resource for other nodes in the fifth realm.

9. The machine-readable medium of claim 8, wherein the access control list includes an identifier of the at least one resource, an identifier of a node, and an identifier of a type of access allowed for the node.

10. The machine-readable medium of claim 8, wherein the access control list includes an identifier of the at least one resource, an identifier of a role, and an identifier of a type of access allowed for the role.

11. A device comprising:
a computer processor;
a non-transitory memory, that stores instructions, which when performed by the computer processor, cause the device to perform operations comprising:
at a parent node in a first realm comprising at least one child node:
determining that a second realm comprising at least one parent node is communicatively reachable to the first realm;
determining to form a third realm comprising the first and second realms as sub-realms through agreement with the parent node of the second realm;
electing, through an election process, the parent node of the first realm as a parent node of the third realm;
provisioning at least one realm service to service at least one request of a child node of the third realm; and
broadcasting the at least one realm service to child nodes of the third realm.

12. The device of claim 11, wherein the at least one realm service comprises one of: a credentials management service, an access management service, a provisioning service, a node discovery service, or a resource discovery service.

13. The device of claim 11, wherein the operations for determining to form a third realm comprising the first and second realms comprises the operations of determining that a policy rule obtained from a server indicates that the first and second realms should form a third realm.

14. The device of claim 11, wherein the operations for provisioning the at least one realm service to service at least one request of the child node of the third realm comprises the operations of providing the at least one realm service at the parent node.

15. The device of claim 14, wherein providing the at least one realm service at the parent node comprises executing instructions from a script obtained over a network from a library of scripts.

16. The device of claim 11, wherein the operations for provisioning the at least one realm service to service at least one request of the child node of the third realm comprises the operations of assigning a child node of the first realm to provide the at least one realm service.

17. The device of claim 11, wherein the operations comprise:
determining that a fourth realm comprising at least one parent node is communicatively reachable to the third realm;
determining, through communication with the parent node of the fourth realm to form a fifth realm comprising the third realm and fourth realm as sub-realms; and
electing, through an election process, the parent node of the fourth realm as a parent node of the fifth realm.

18. The device of claim 17, wherein the operations comprise: providing a first access control list for the third realm and a second access control list for the fifth realm, the first access control list specifying access controls for at least one resource of the parent node for other nodes in the third realm, the second access control list specifying access controls for the at least one resource for other nodes in the fifth realm.

19. The device of claim 18, wherein the access control list includes an identifier of the at least one resource, an identifier of a node, and an identifier of a type of access allowed for the node.

20. The device of claim 18, wherein the access control list includes an identifier of the at least one resource, an identifier of a role, and an identifier of a type of access allowed for the role.

21. A method comprising:
at a parent node in a first realm comprising at least one child node, using a computer processor:
determining that a second realm comprising at least one parent node is communicatively reachable to the first realm;
determining to form a third realm comprising the first and second realms as sub-realms through agreement with the parent node of the second realm;
electing, through an election process, the parent node of the first realm as a parent node of the third realm;
provisioning at least one realm service to service at least one request of a child node of the third realm; and
broadcasting the at least one realm service to child nodes of the third realm.

22. The method of claim 21, wherein the at least one realm service comprises one of: a credentials management service, an access management service, a provisioning service, a node discovery service, or a resource discovery service.

23. The method of claim 21, wherein determining to form a third realm comprising the first and second realms comprises determining that a policy rule obtained from a server indicates that the first and second realms should form a third realm.

24. The method of claim 21, wherein provisioning the at least one realm service to service at least one request of the child node of the third realm comprises providing the at least one realm service at the parent node.
